(19) United States
(12) Patent Application Publication
(10) Pub. No.: US 2011/0126094 A1
(43) Pub. Date: May 26, 2011

(54) METHOD OF MODIFYING COMMANDS ON A TOUCH SCREEN USER INTERFACE

(76) Inventors: Samuel J. Horodezky, San Diego, CA (US); Per O. Nielsen, Chula Vista, CA (US)

(21) Appl. No.: 12/625,182

(22) Filed: Nov. 24, 2009

(51) Int. Cl. G06F 3/048

(52) U.S. Cl. 715/702; 715/863

(57) ABSTRACT

A method of modifying commands is disclosed and may include detecting an initial command gesture and determining whether a first subsequent command gesture is detected. Further, the method may include executing a base command when a first subsequent command gesture is not detected and executing a first modified command when a first subsequent command gesture is detected.

### DESCRIPTION OF THE RELATED ART

Portable computing devices (PDs) are ubiquitous. These devices may include cellular telephones, portable digital assistants (PDAs), portable game consoles, palmtop computers, and other portable electronic devices. Many portable computing devices include a touch screen user interface in which a user may interact with the device and input commands. Inputting multiple commands or altering based commands via a touch screen user interface may be difficult and tedious.

Accordingly, what is needed is an improved method of modifying commands received via a touch screen user interface.

### BRIEF DESCRIPTION OF THE DRAWINGS

In the figures, like reference numerals refer to like parts throughout the various views unless otherwise indicated.

FIG. 1 is a front plan view of a first aspect of a portable computing device (PCD) in a closed position;

FIG. 2 is a front plan view of the first aspect of a PCD in an open position;

FIG. 3 is a block diagram of a second aspect of a PCD;

FIG. 4 is a cross-section view of a third aspect of a PCD;

FIG. 5 is a cross-section view of a fourth aspect of a PCD;

FIG. 6 is a cross-section view of a fifth aspect of a PCD;

FIG. 7 is another cross-section view of the fifth aspect of a PCD;

FIG. 8 is a flowchart illustrating a first aspect of a method of modifying commands;

FIG. 9 is a flowchart illustrating a second aspect of a method of modifying commands;

FIG. 10 is a flowchart illustrating a third aspect of a method of modifying commands; and

FIG. 11 is a flowchart illustrating a fourth aspect of a method of modifying commands.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

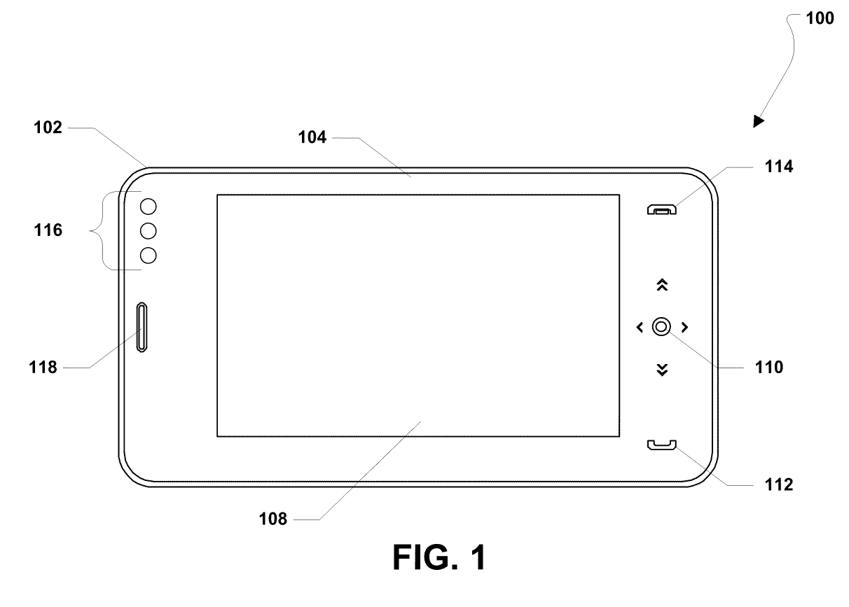

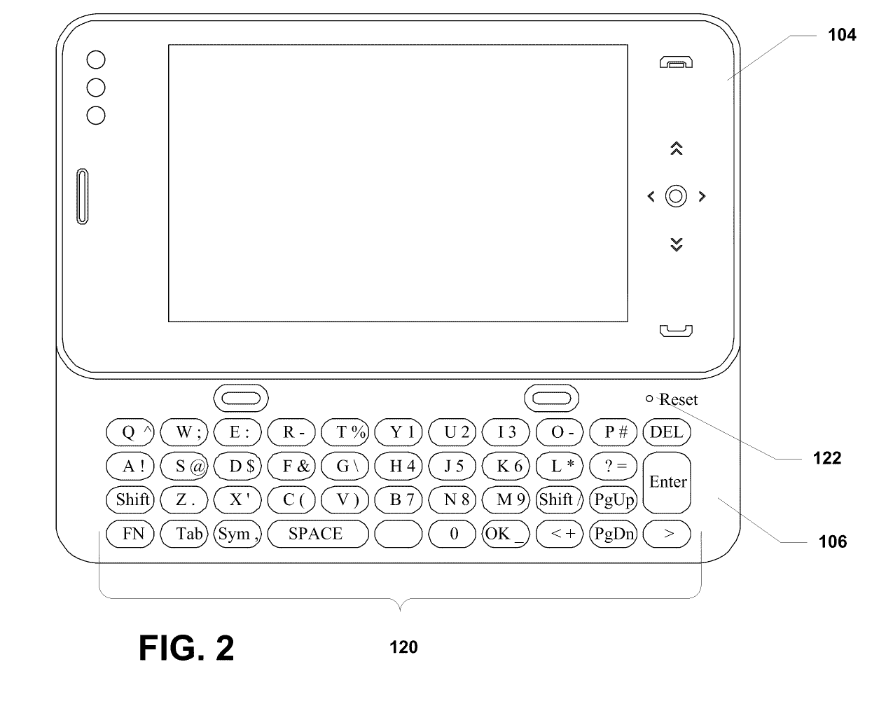

Referring initially to FIG. 1 and FIG. 2, a first aspect of a portable computing device (PCD) is shown and is generally designated 100. As shown, the PCD 100 may include a housing 102. The housing 102 may include an upper housing portion 104 and a lower housing portion 106. FIG. 1 shows that the upper housing portion 104 may include a display 108. In a particular aspect, the display 108 may be a touch screen display. The upper housing portion 104 may also include a trackball input device 110. Further, as shown in FIG. 1, the upper housing portion 104 may include a power on button 112 and a power off button 114. As shown in FIG. 1, the upper housing portion 104 of the PCD 100 may include a plurality of indicator lights 116 and a speaker 118. Each indicator light 116 may be a light emitting diode (LED).

In a particular aspect, as depicted in FIG. 2, the upper housing portion 104 is movable relative to the lower housing portion 106. Specifically, the upper housing portion 104 may be slidable relative to the lower housing portion 106. As shown in FIG. 2, the lower housing portion 106 may include a multi-button keyboard 120. In a particular aspect, the multi-button keyboard 120 may be a standard QWERTY keyboard. The multi-button keyboard 120 may be revealed when the upper housing portion 104 is moved relative to the lower housing portion 106. FIG. 2 further illustrates that the PCD 100 may include a reset button 122 on the lower housing portion 106.

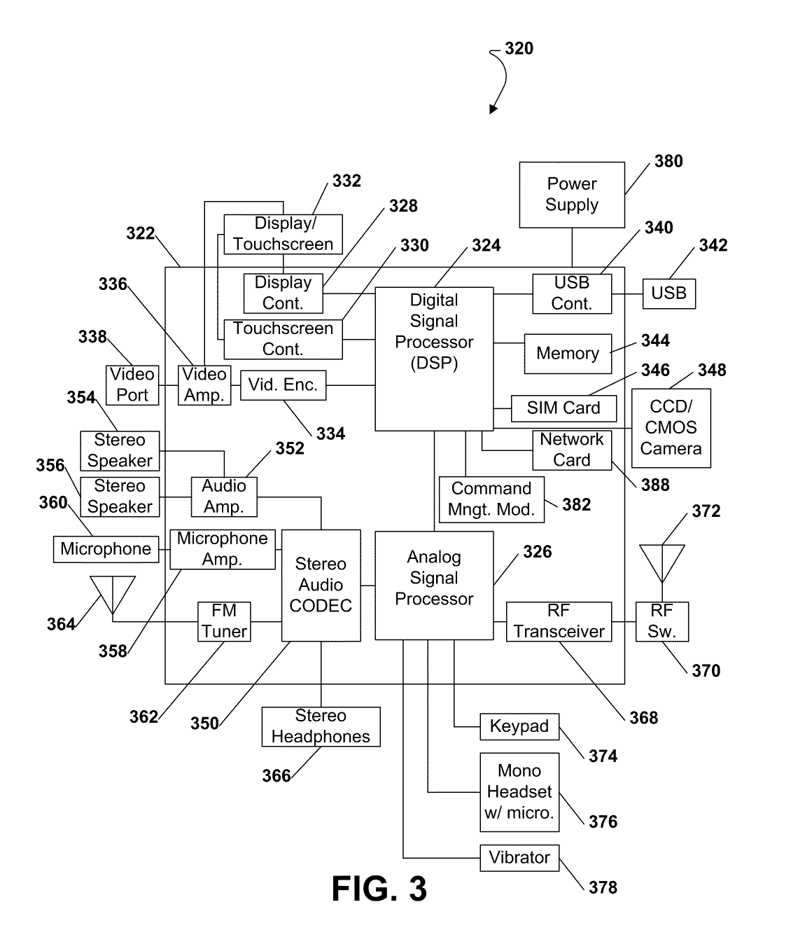

Referring to FIG. 3, a second aspect of a portable computing device (PCD) is shown and is generally designated 320. As shown, the PCD 320 includes an on-chip system 322 that includes a digital signal processor 324 and an analog signal processor 326 that are coupled together. The on-chip system 322 may include more than two processors. For example, the on-chip system 322 may include four core processors and an ARM 11 processor, i.e., as described below in conjunction with FIG. 32.

As illustrated in FIG. 3, a display controller 328 and a touch screen controller 330 are coupled to the digital signal processor 324. In turn, a touch screen display 332 external to the on-chip system 322 is coupled to the display controller 328 and the touch screen controller 330. In particular aspect, the touch screen controller 330, the touch screen display 332, or a combination thereof may act as a means for detecting one or more command gestures.

FIG. 3 further indicates that a video encoder 334, e.g., a phase alternating line (PAL) encoder, a sequential couleur a memoire (SECAM) encoder, or a national television system(s) committee (NTSC) encoder, is coupled to the digital signal processor 324. Further, a video amplifier 336 is coupled to the video encoder 334 and the touch screen display 332. Also, a video port 338 is coupled to the video amplifier 336. As depicted in FIG. 3, a universal serial bus (USB) controller 340 is coupled to the digital signal processor 324. Also, a USB port 342 is coupled to the USB controller 340. A memory 344 and a subscriber identity module (SIM) card 346 may also be coupled to the digital signal processor 324. Further, as shown in FIG. 3, a digital camera 348 may be coupled to the digital signal processor 324. In an exemplary aspect, the digital camera 348 is a charge-coupled device (CCD) camera or a complementary metal-oxide semiconductor (CMOS) camera.

As further illustrated in FIG. 3, a stereo audio CODEC 350 may be coupled to the analog signal processor 326. Moreover, an audio amplifier 352 may coupled to the stereo audio CODEC 350. In an exemplary aspect, a first stereo speaker 354 and a second stereo speaker 356 are coupled to the audio amplifier 352. FIG. 3 shows that a microphone amplifier 358 may be also coupled to the stereo audio CODEC 350. Additionally, a microphone 360 may be coupled to the microphone amplifier 358. In a particular aspect, a frequency modulation (FM) radio tuner 362 may be coupled to the stereo audio CODEC 350. Also, an FM antenna 364 is coupled to the FM radio tuner 362. Further, stereo headphones 366 may be coupled to the stereo audio CODEC 350.

FIG. 3 further indicates that a radio frequency (RF) transceiver 368 may be coupled to the analog signal processor 326. An RF switch 370 may be coupled to the RF transceiver 368 and an RF antenna 372. As shown in FIG. 3, a keypad 374 may be coupled to the analog signal processor 326. Also, a mono headset with a microphone 376 may be coupled to the analog signal processor 326. Further, a vibrator device 378 may be coupled to the analog signal processor 326. FIG. 3 also shows that a power supply 380 may be coupled to the on-chip system 322. In a particular aspect, the power supply 380 is a direct current (DC) power supply that provides power to the various components of the PCD 320 that require power. Further, in a particular aspect, the power supply is a rechargeable DC battery or a DC power supply that is derived from an alternating current (AC) to DC transformer that is connected to an AC power source.

FIG. 3 indicates that the PCD 320 may include a command management module 382. The command management module 382 may be a stand-alone controller or it may be within the memory 344.

FIG. 3 further indicates that the PCD 320 may also include a network card 388 that may be used to access a data network, e.g., a local area network, a personal area network, or any other network. The network card 388 may be a Bluetooth network card, a WiFi network card, a personal area network (PAN) card, a personal area network ultra-low-power technology (PeANUT) network card, or any other network card well known in the art. Further, the network card 388 may be incorporated into a chip, i.e., the network card 388 may be a full solution in a chip, and may not be a separate network card 388.

As depicted in FIG. 3, the touch screen display 332, the video port 338, the USB port 342, the camera 348, the first stereo speaker 354, the second stereo speaker 356, the microphone 360, the FM antenna 364, the stereo headphones 366, the RF switch 370, the RF antenna 372, the keypad 374, the mono headset 376, the vibrator 378, and the power supply 380 are external to the on-chip system 322.

In a particular aspect, one or more of the method steps described herein may be stored in the memory 344 as computer program instructions. These instructions may be executed by a processor 324, 326 in order to perform the methods described herein. Further, the processors 324, 326, the memory 344, the command management module 382, the display controller 328, the touch screen controller 330, or a combination thereof may serve as a means for executing one or more of the method steps described herein in order to control a virtual keyboard displayed at the display/touch screen 332.

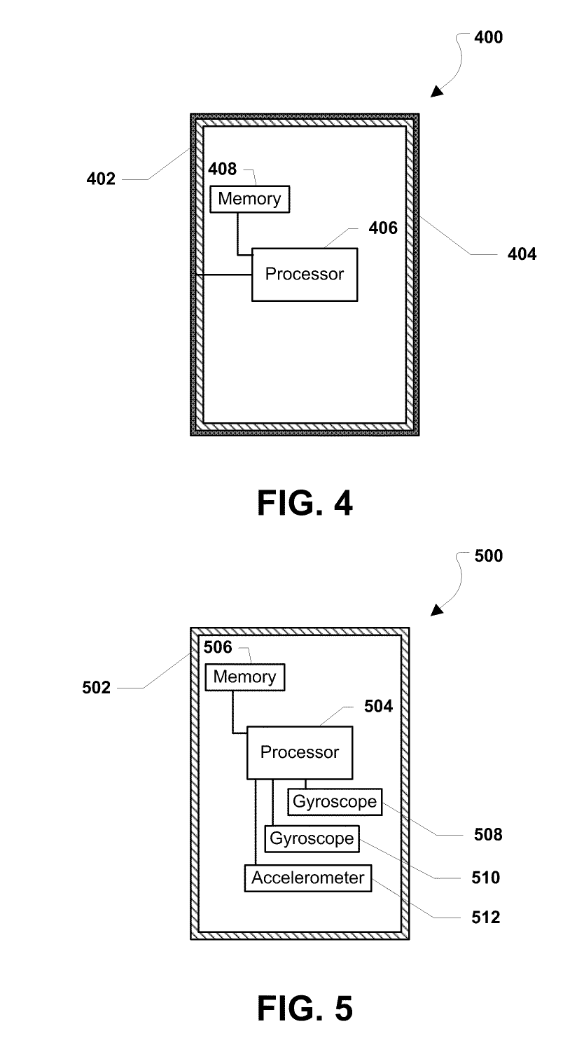

Referring to FIG. 4, a third aspect of a PCD is shown and is generally designated 400. FIG. 4 shows the PCD in cross-section. As shown, the PCD 400 may include a housing 402. In a particular aspect, one or more of the elements shown in conjunction with FIG. 3 may be disposed, or otherwise installed, within the inner housing 402. However, for clarity, only a processor 404 and a memory 406, connected thereto, are shown within the housing 402.

Additionally, the PCD 400 may include a pressure sensitive layer 408 disposed on the outer surface of the housing 402. In a particular embodiment, the pressure sensitive layer 408 may include a piezoelectric material deposited or otherwise disposed on the housing 402. The pressure sensitive layer 408 may detect when a user squeezes, or otherwise presses, the PCD 400 at nearly any location on the PCD 400. Further, depending on where the PCD 400 is pressed, or squeezed, one or more base commands may be modified as described in detail herein.

FIG. 5 depicts another aspect of a PCD, generally designated 500. FIG. 5 shows the PCD 500 in cross-section. As shown, the PCD 500 may include a housing 502. In a particular aspect, one or more of the elements shown in conjunction with FIG. 3 may be disposed, or otherwise installed, within the inner housing 502. However, for clarity, only a processor 504 and a memory 506, connected thereto, are shown within the housing 502.

Additionally, the PCD 500 may include a first gyroscope 508, a second gyroscope 510, and an accelerometer 512 connected to the processor 504 within the PCD. The gyroscopes 508, 510 and the accelerometer 512 may be used to detect when linear motion and acceleration motion. Using this data, “virtual buttons” may be detected. In other words, a user may press one side of the PCD 500 and the gyroscopes 508, 510 and the accelerometer 512 may detect that press. Further, depending on where the PCD 500 is pressed one or more base commands may be modified as described in detail herein.

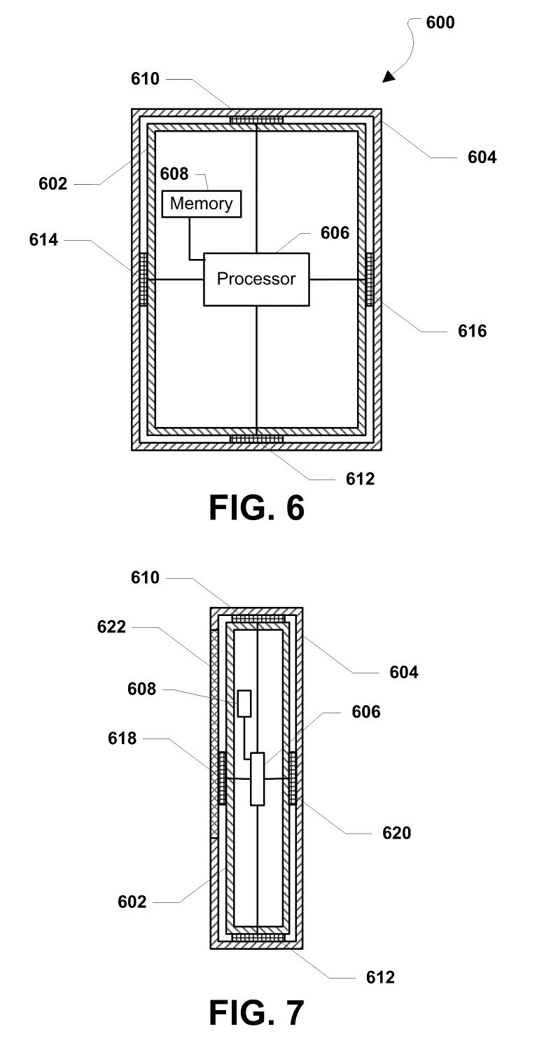

FIG. 6 and FIG. 7 illustrate a fifth a PCD, generally designated 600. FIG. 6 and FIG. 7 show the PCD 600 in cross-section. As shown, the PCD 600 may include an inner housing 602 and an outer housing 604. In a particular aspect, one or more of the elements shown in conjunction with FIG. 3 may be disposed, or otherwise installed, within the inner housing 602. However, for clarity, only a processor 606 and a memory 608, connected thereto, are shown within the inner housing 602.

FIG. 6 and FIG. 7 indicate that an upper pressure sensor 610 and a lower pressure sensor 612 may be disposed between the inner housing 602 and the outer housing 604. Moreover, a left pressure sensor 614 and a right pressure sensor 616 may be disposed between the inner housing 602 and the outer housing 604. As shown, a front pressure sensor 618 and a rear pressure sensor 620 may also be disposed between the inner housing 602 and the outer housing 604. The front pressure sensor 618 may be located behind a display 622 and the display may be pressed in order to activate the front pressure sensor 618 as described herein. In a particular aspect, one or more of the sensors 610, 612, 614, 616, 618, 620 may act as a means for detecting one or more command gestures. Further, the sensors 610, 612, 614, 616, 618, 620 may be considered a six-axis sensor array.

In a particular aspect, the inner housing 602 may be substantially rigid. Moreover, the inner housing 602 may be made from a material having an elastic modulus in a range of forty gigapascals to fifty gigapascals (40.0-50.0 GPa). For example, the inner housing 602 may be made from a magnesium alloy, such as AM-lite, AM-HP2, AZ91D, or a combination thereof. The outer housing 604 may be elastic. Specifically, the outer housing 604 may be made from a material having an elastic modulus in a range of one-half gigapascal to four gigapascals (0.5-6.0 GPa). For example, the outer housing 604 may be made from a polymer such as High Density Polyethylene (HDPE), polytetrafluoroethylene (PTFE), nylon, poly(acrylonitrile, butadiene, styrene (ABS), acrylic, or a combination thereof.

Since the inner housing 602 is substantially rigid and the outer housing 604 is elastic, when a user squeezes the outer housing 604, one or more of the pressure sensors 610, 612, 614, 616, 618, 620 may be squeezed between the inner housing 604 and the outer housing 602 and activated.

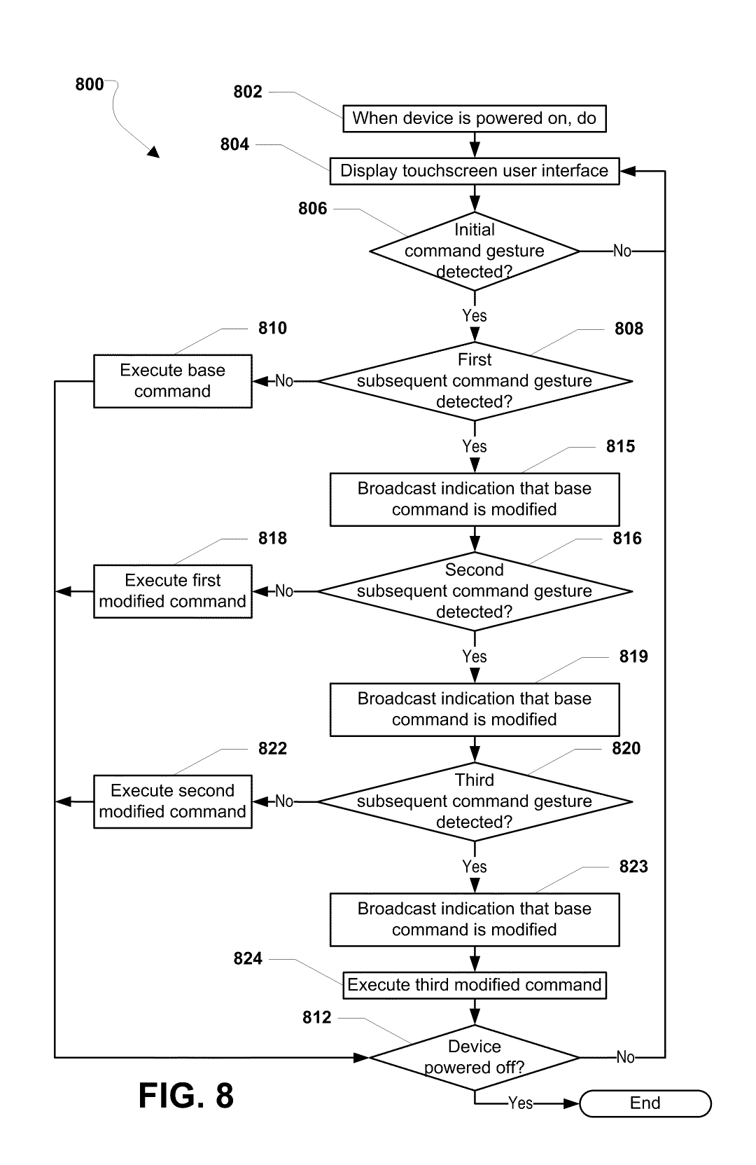

Referring now to FIG. 8, a method of altering user interface commands is shown and is generally designated 800. Beginning at block 802, when a device is powered on, the following steps may be performed. At block 804, a user interface may be displayed. At decision 806, a command management module may determine whether an initial command gesture is detected. In a particular aspect, the initial command gesture may be a touch on a touch screen. If an initial command gesture is not detected, the method 800 may return to block 804 and continue as described herein. On the other hand, if an initial command gesture is detected, the method 800 may proceed to decision 808.

At decision 808, the command management module may determine whether a first subsequent command gesture is detected within a predetermined time period, e.g., a tenth of a second, a half of a second, a second, etc. In a particular aspect, the first subsequent command gesture may include a hard button press, an additional touch on a touch screen by another finger (or thumb), a squeeze on the device housing in order to activate a pressure sensor or pressure sensitive material, a tap on the device housing sensed by a six-axis sensor, presence or absence of light, a location determined using a global positioning system (GPS), presence or absence of an object in a camera viewfinder, etc.

If a first subsequent command gesture is not detected, a base command may be executed at block 810. Then, the method 800 may move to decision 812 and it may be determined whether the device is powered off. If the device is not powered off, the method 800 may return to block 804 and the method 800 may continue as described herein. Conversely, if the device is powered off, the method 800 may end.

Returning to decision 808, if a first subsequent command gesture is detected within the predetermined time period, the method 800 may move to block 815. At block 815, the command management module may broadcast an indication that the base command is modified. For example, the indication may be a visual indication, an audible indication, or a combination thereof. The visual indication may be a symbolic representation of the modified command, a text representation of the modified command, a color representation of the modified command, or a combination thereof. The visual indication may be a cluster of pixels that get brighter when a base command is modified (or further modified as described below), that change colors when a base command is modified (or further modified as described below), that change color shades when a base command is modified (or further modified as described below), or a combination thereof. The audible indication may be a beep, a ding, a voice string, or a combination thereof. The audible indication may get louder as a base command is modified (or further modified as described below).

From block 815, the method 800 may proceed to decision 816. At decision 816, the command management module may determine whether a second subsequent command gesture is detected within a predetermined time period, e.g., a tenth of a second, a half of a second, a second, etc. In a particular aspect, the second subsequent command gesture may include a hard button press, an additional touch on a touch screen by another finger (or thumb), a squeeze on the device housing in order to activate a pressure sensor or pressure sensitive material, a tap on the device housing sensed by a six-axis sensor, presence or absence of light, a location determined using a global positioning system (GPS), presence or absence of an object in a camera viewfinder, etc.

If a second subsequent command gesture is not detected within the predetermined time period, the method 800 may move to block 818 and a first modified command may be executed. The method 800 may then proceed to decision 812 and continue as described herein. Returning to decision 816, if a second subsequent command gesture is detected within the predetermined time period, the method 800 may move to block 819. At block 819, the command management module may broadcast an indication that the base command is further modified. For example, the indication may be a visual indication, an audible indication, or a combination thereof. The visual indication may be a symbolic representation of the modified command, a text representation of the modified command, a color representation of the modified command, or a combination thereof. The visual indication may be a cluster of pixels that get brighter when a base command is modified (or further modified as described below), that change colors when a base command is modified (or further modified as described below), that change color shades when a base command is modified (or further modified as described below), or a combination thereof. The audible indication may be a beep, a ding, a voice string, or a combination thereof. The audible indication may get louder as a base command is modified (or further modified as described below).

From block 819, the method 800 may proceed to decision 820. At decision 820, the command management module may determine whether a third subsequent command gesture is detected is detected within a predetermined time period, e.g., a tenth of a second, a half of a second, a second, etc. In a particular aspect, the third subsequent command gesture may include a hard button press, an additional touch on a touch screen by another finger (or thumb), a squeeze on the device housing in order to activate a pressure sensor or pressure sensitive material, a tap on the device housing sensed by a six-axis sensor, presence or absence of light, a location determined using a global positioning system (GPS), presence or absence of an object in a camera viewfinder, etc. If a third subsequent command gesture is not detected, a second modified command may be executed at block 822. The method 800 may then proceed to decision 812 and continue as described herein.

Returning to decision 820, if a third subsequent command gesture is detected, the method 800 may move to block 823. At block 823, the command management module may broadcast an indication that the base command is, once again, further modified. For example, the indication may be a visual indication, an audible indication, or a combination thereof. The visual indication may be a symbolic representation of the modified command, a text representation of the modified command, a color representation of the modified command, or a combination thereof. The visual indication may be a cluster of pixels that get brighter when a base command is modified (or further modified as described below), that change colors when a base command is modified (or further modified as described below), that change color shades when a base command is modified (or further modified as described below), or a combination thereof. The audible indication may be a beep, a ding, a voice string, or a combination thereof. The audible indication may get louder as a base command is modified (or further modified as described below).

From block 823, the method 800 may proceed to block 824 and a third modified command may be executed. Thereafter, the method 800 may then proceed to decision 812 and continue as described herein.

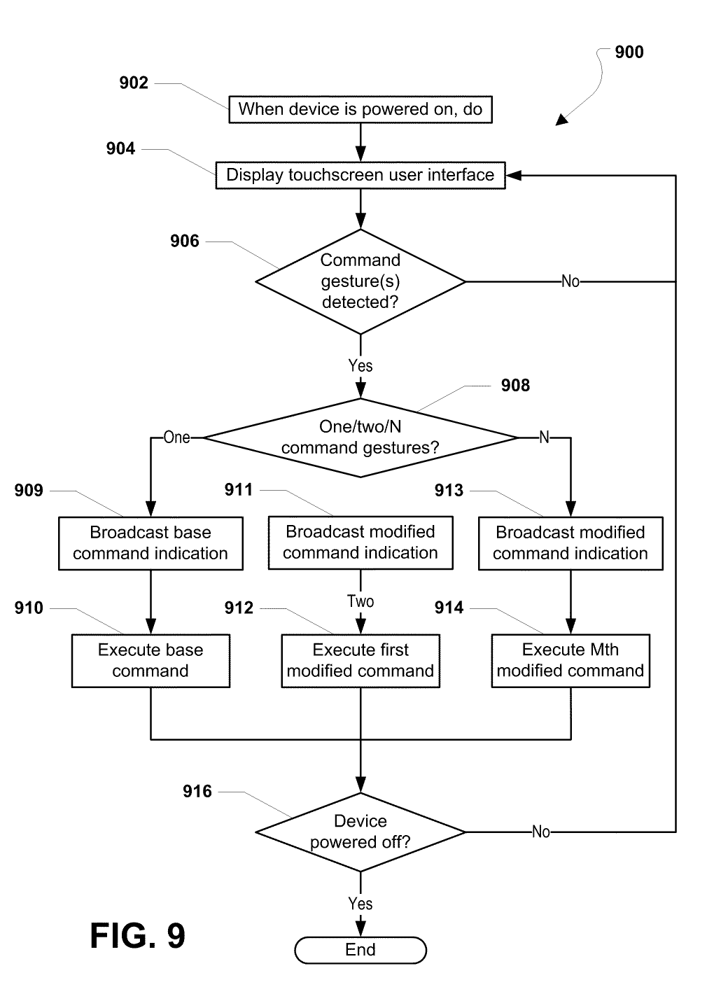

Referring to FIG. 9, another aspect of a method of altering user interface commands is shown and is generally designated 900. Commencing at block 902, when a device is powered on, the following steps may be performed. At block 904, a touch screen user interface may be displayed. At decision 906, a command management module may determine whether one or more command gestures are detected. In this aspect, the one or more command gestures may include one or more hard button presses, one or more touches on a touch screen, one or more squeezes on different areas of the device housing in order to activate pressure sensors or various locations of pressure sensitive materials, one or more taps on the device housing sensed by a six-axis sensor, presence or absence of light, a location determined using a global positioning system (GPS), presence or absence of an object in a camera viewfinder, or a combination thereof.

If one or more commands gestures are not detected, the method 900 may return to block 904 and continue as described herein. Conversely, if one or more command gestures are detected, the method 900 may proceed to decision 908 and the command management module may determine whether one, two, or N command gestures have been detected.

If one command gesture is detected, the method may proceed to block 909 and a command indication may be broadcast to the user. For example, the command indication may be a visual indication, an audible indication, or a combination thereof. The visual indication may be a symbolic representation of the modified command, a text representation of the modified command, a color representation of the modified command, or a combination thereof. The visual indication may be a cluster of pixels that illuminate when a base command is selected, that change colors when a base command is selected, that change color shades when a base command is selected, or a combination thereof. The audible indication may be a beep, a ding, a voice string, or a combination thereof. Moving to block 910, a base command may be executed.

Returning to decision 908, if two command gestures are detected, the method 400 may move to block 911 and a modified command indication may be broadcast to the user. The modified command indication may be a visual indication, an audible indication, or a combination thereof. The visual indication may be a symbolic representation of the modified command, a text representation of the modified command, a color representation of the modified command, or a combination thereof. The visual indication may be a cluster of pixels that get brighter when a base command is modified, that change colors when a base command is modified, that change color shades when a base command is modified, or a combination thereof. The audible indication may be a beep, a ding, a voice string, or a combination thereof. The audible indication may get louder as a base command is modified, change tone as a base command is modified, change pitch as a base command is modified, or a combination thereof. Proceeding to block 912, a first modified command may be executed.

Returning to decision 908, if N command gestures are detected, the method 900 may proceed to block 913 and a modified command indication may be broadcast. The modified command indication may be a visual indication, an audible indication, or a combination thereof. The visual indication may be a symbolic representation of the modified command, a text representation of the modified command, a color representation of the modified command, or a combination thereof. The visual indication may be a cluster of pixels that get brighter when a base command is modified, that change colors when a base command is further modified, that change color shades when a base command is further modified, or a combination thereof. The audible indication may be a beep, a ding, a voice string, or a combination thereof. The audible indication may get louder as a base command is further modified, change tone as a base command is further modified, change pitch as a base command is further modified, or a combination thereof. Continuing to block 914, an Mth modified command may be executed.

From block 910, block 912, or block 914, the method 900 may proceed to decision 916 and it may be determined whether the device is powered off. If the device is not powered off, the method 900 may return to block 904 and the method 900 may continue as described herein. Conversely, if the device is powered off, the method 900 may end.

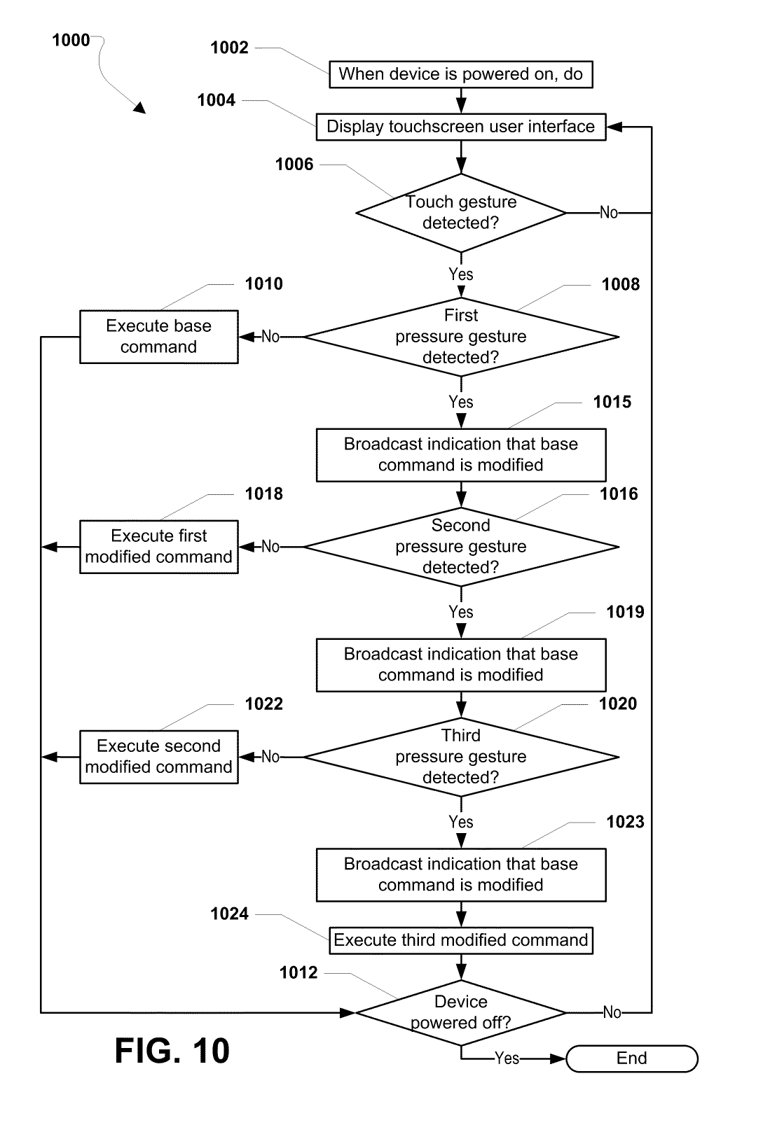

Referring to FIG. 10, yet another aspect of a method of altering user interface commands is shown and is generally designated 1000. Beginning at block 1002, when a device is powered on, the following steps may be performed. At block 1004, a user interface may be displayed. At decision 1006, a command management module may determine whether a touch gesture is detected. In a particular aspect, the touch gesture may be a touch on a touch screen with a finger, a thumb, a stylus, or a combination thereof. If a touch gesture is not detected, the method 1000 may return to block 1004 and continue as described herein. On the other hand, if a touch gesture is detected, the method 1000 may proceed to decision 1008.

At decision 1008, the command management module may determine whether a first pressure gesture is detected. The first pressure gesture may be substantially simultaneous with the touch gesture or subsequent to the touch gesture within a predetermined time period, e.g., a tenth of a second, a half of a second, a second, etc. In a particular aspect, the first pressure gesture may include a squeeze on the device housing in order to activate a pressure sensor or pressure sensitive material, a tap on the device housing sensed by a six-axis sensor, or a combination thereof.

If a first pressure gesture is not detected, a base command may be executed at block 1010. Then, the method 1000 may move to decision 1012 and it may be determined whether the device is powered off. If the device is not powered off, the method 1000 may return to block 1004 and the method 1000 may continue as described herein. Conversely, if the device is powered off, the method 1000 may end.

Returning to decision 1008, if a first pressure gesture is detected within the predetermined time period, the method 1000 may move to block 1015. At block 1015, the command management module may broadcast an indication that the base command is modified. For example, the indication may be a visual indication, an audible indication, or a combination thereof. The visual indication may be a symbolic representation of the modified command, a text representation of the modified command, a color representation of the modified command, or a combination thereof. The visual indication may be a cluster of pixels that get brighter when a base command is modified (or further modified as described below), that change colors when a base command is modified (or further modified as described below), that change color shades when a base command is modified (or further modified as described below), or a combination thereof. The audible indication may be a beep, a ding, a voice string, or a combination thereof. The audible indication may get louder as a base command is modified (or further modified as described below).

From block 1015, the method 1000 may proceed to decision 1016. At decision 1016, the command management module may determine whether a second pressure gesture is detected. The second pressure gesture may be substantially simultaneous with the touch gesture and the first pressure gesture or subsequent to the touch gesture and the first pressure gesture within a predetermined time period, e.g., a tenth of a second, a half of a second, a second, etc. In a particular aspect, the second pressure gesture may a squeeze on the device housing in order to activate a pressure sensor or pressure sensitive material, a tap on the device housing sensed by a six-axis sensor, or a combination thereof.

If a second pressure gesture is not detected within the predetermined time period, the method 1000 may move to block 1018 and a first modified command may be executed. The method 1000 may then proceed to decision 1012 and continue as described herein. Returning to decision 1016, if a second pressure gesture is detected within the predetermined time period, the method 1000 may move to block 1019. At block 1019, the command management module may broadcast an indication that the base command is further modified. For example, the indication may be a visual indication, an audible indication, or a combination thereof. The visual indication may be a symbolic representation of the modified command, a text representation of the modified command, a color representation of the modified command, or a combination thereof. The visual indication may be a cluster of pixels that get brighter when a base command is modified (or further modified as described below), that change colors when a base command is modified (or further modified as described below), that change color shades when a base command is modified (or further modified as described below), or a combination thereof. The audible indication may be a beep, a ding, a voice string, or a combination thereof. The audible indication may get louder as a base command is modified (or further modified as described below).

From block 1019, the method 1000 may proceed to decision 1020. At decision 1020, the command management module may determine whether a third pressure gesture is detected. The third pressure gesture may be substantially simultaneous to the touch gesture, the first pressure gesture, the second pressure gesture, or a combination thereof, or subsequent to the touch gesture, the first pressure gesture, the second pressure, or a combination thereof within a predetermined time period, e.g., a tenth of a second, a half of a second, a second, etc. In a particular aspect, the third pressure gesture may include a squeeze on the device housing in order to activate a pressure sensor or pressure sensitive material, a tap on the device housing sensed by a six-axis sensor, or a combination thereof.

If a third pressure gesture is not detected, a second modified command may be executed at block 1022. The method 1000 may then proceed to decision 1012 and continue as described herein.

Returning to decision 1020, if a third pressure gesture is detected, the method 1000 may move to block 1023. At block 1023, the command management module may broadcast an indication that the base command is, once again, further modified. For example, the indication may be a visual indication, an audible indication, or a combination thereof. The visual indication may be a symbolic representation of the modified command, a text representation of the modified command, a color representation of the modified command, or a combination thereof. The visual indication may be a cluster of pixels that get brighter when a base command is modified (or further modified as described below), that change colors when a base command is modified (or further modified as described below), that change color shades when a base command is modified (or further modified as described below), or a combination thereof. The audible indication may be a beep, a ding, a voice string, or a combination thereof. The audible indication may get louder as a base command is modified (or further modified as described below).

From block 1023, the method 1000 may proceed to block 1024 and a third modified command may be executed. Thereafter, the method 1000 may then proceed to decision 1012 and continue as described herein.

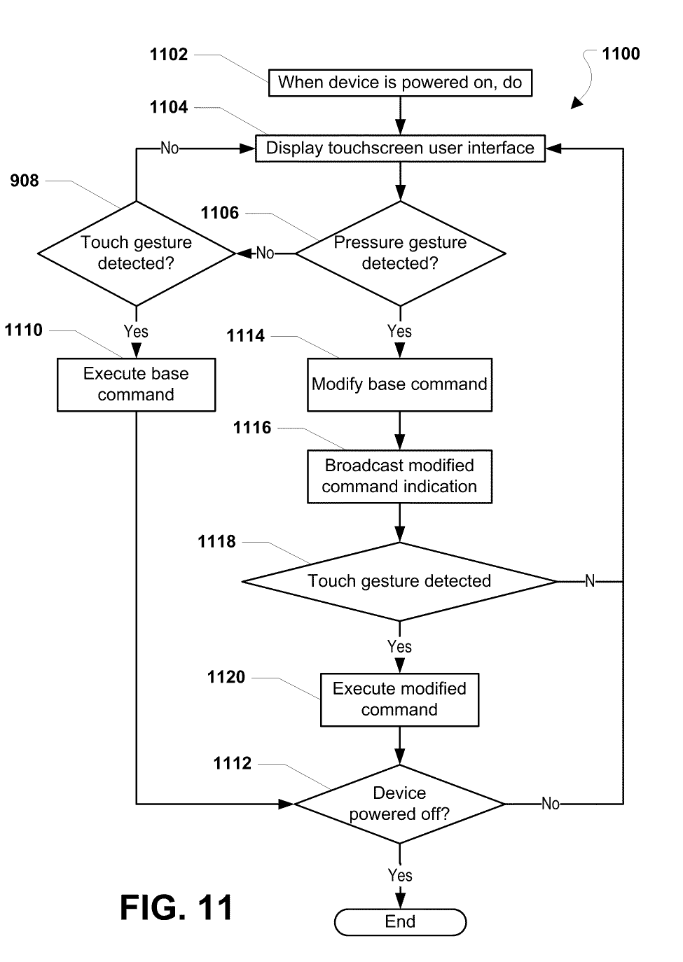

FIG. 11 illustrates still another aspect of a method of altering user interface commands, is generally designated 1100. Commencing at block 1102, when a device is powered on, the following steps may be performed. At block 1104, a touch screen user interface may be displayed. At decision 1106, a command management module may determine whether one or more pressure gestures are detected. In this aspect, the one or more pressure gestures may include one or more squeezes on different areas of the device housing in order to activate pressure sensors or various locations of pressure sensitive materials, one or more taps on the device housing sensed by a six-axis sensor, or a combination thereof.

If one or more pressure gestures are not detected, the method 1100 may move to decision 1108 and the command management module may determine whether a touch gesture is detected. If not, the method 1100 may return to block 1104 and continue as described herein. Otherwise, if a touch gesture is detected, the method 1100 may continue to block 1110 and a base command may be executed. Then, the method 1100 may proceed to decision 1112 and it may be determined whether the device is powered off. If the device is powered off, the method 1100 may end. If the device is not powered off, the method 1100 may return to block 1104 and continue as described herein.

Returning to decision 1106, if a pressure gesture is detected, the method 1100 may move to block 1114 and the command management module may modify a base command. Depending on the number of pressure gestures detected the base command may be modified to a first modified command, a second modified command, a third modified command, an Nth modified command, etc.

From block 1114, the method 1100 may move to block 1116 and a modified command indication may be broadcast. For example, the command indication may be a visual indication, an audible indication, or a combination thereof. The visual indication may be a symbolic representation of the modified command, a text representation of the modified command, a color representation of the modified command, or a combination thereof. The visual indication may be a cluster of pixels that illuminate when a base command is selected, that change colors when a base command is selected, that change color shades when a base command is selected, or a combination thereof. The audible indication may be a beep, a ding, a voice string, or a combination thereof.

Moving to decision 1118, it may be determined whether a touch gesture is detected. If not, the method 1100 may return to block 1104 and continue as described herein. In a particular aspect, before the method 1100 returns to block 1104, the modified base command may be reset to the base command.

Returning to decision 1118, if a touch gesture is detected, the method 1100 may continue to block 1120 and a modified command may be executed. Thereafter, the method 1100 may move to decision 1112 and continue as described herein.

It is to be understood that the method steps described herein need not necessarily be performed in the order as described. Further, words such as “thereafter,” “then,” “next,” etc. are not intended to limit the order of the steps. These words are simply used to guide the reader through the description of the method steps.

The methods disclosed herein provide ways to modify commands. For example, a command typically performed in response to a command gesture such as a single touch by a user may be modified with a second touch by the user so that two fingers, or a finger and a thumb, are touching the touch screen user interface. A single touch may place a curser in a text field and two fingers in the same place may initiate a cut function or copy function. Also, three fingers touching at the same time may represent a paste command.

In another aspect, moving a single finger over a map displayed on a touch screen display may cause the map to pan. Touching the map with two fingers may cause the map to zoom. This aspect may be also used to view and manipulate photos. If a home screen includes widgets and/or gadgets, a single touch may be used for commands within the widget, e.g., to place a cursor or select an item. Further, two fingers may be used to move the widget to a new location.

In another aspect, if an application in a main menu has one instance open in an application stack, a two finger touch may open a second instance of the application rather than open the current instance. Further, in another aspect, in a contacts application a single touch may select a list item, a two finger touch may open an edit mode, and a three finger touch could place a call to a selected contact. Also, in another aspect, in a scheduler application, a single touch on an event may open the event, a two finger touch may affect an event's status, e.g., marking it tentative, setting it to out of office, cancelling the event, dismissing the event, etc. In another aspect, in an email application containing many emails, a single touch may select an email item for viewing, a two finger touch may enter a mark mode, e.g., for multiple deletion, for moving, etc.

In a particular aspect, an initial command gesture may be a touch on a touch screen. Subsequent command gestures may include additional touches on the touch screen. In another aspect, subsequent command gestures may include pressure gestures, i.e., activation of one or more sensors within a six-axis sensor array. In another aspect, an initial command gesture may include a pressure gesture. Subsequent command gestures may include one or more touches on a touch screen. Subsequent command gestures may also include one or more pressure gestures.

In one or more exemplary aspects, the functions described may be implemented in hardware, software, firmware, or any combination thereof. If implemented in software, the functions may be stored on or transmitted over as one or more instructions or code on a machine readable medium, i.e., a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A method of modifying commands at a portable computing device, the method comprising:
detecting an initial command gesture;
determining whether a first subsequent command gesture is detected;
executing a base command when a first subsequent command gesture is not detected; and
executing a first modified command when a first subsequent command gesture is detected.

2. The method of claim 1, further comprising:
determining whether a second subsequent command gesture is detected;
executing a first modified command when a second subsequent command gesture is not detected; and
executing a second modified command when a second subsequent command gesture is detected.

3. The method of claim 2, further comprising:
determining whether a third subsequent command gesture is detected;
executing a second modified command when a third subsequent command gesture is not detected; and
executing a third modified command when a third subsequent command gesture is detected.

4. The method of claim 1, wherein detecting an initial command gesture comprises detecting a first touch on a touch screen user interface.

5. The method of claim 4, wherein detecting a first subsequent command gesture comprises detecting a second touch on a touch screen user interface.

6. The method of claim 2, wherein detecting a second subsequent command gesture comprises detecting a third touch on a touch screen user interface.

7. The method of claim 3, wherein detecting a third subsequent command gesture comprises detecting a fourth touch on a touch screen user interface.

8. A portable computing device, comprising:
means for detecting an initial command gesture;
means for determining whether a first subsequent command gesture is detected;
means for executing a base command when a first subsequent command gesture is not detected; and
means for executing a first modified command when a first subsequent command gesture is detected.

9. The method of claim 8, further comprising:
means for determining whether a second subsequent command gesture is detected;
means for executing a first modified command when a second subsequent command gesture is not detected; and
means for executing a second modified command when a second subsequent command gesture is detected.

10. The method of claim 9, further comprising:
means for determining whether a third subsequent command gesture is detected;
means for executing a second modified command when a third subsequent command gesture is not detected; and
means for executing a third modified command when a third subsequent command gesture is detected.

11. The method of claim 8, wherein the means for detecting an initial command gesture comprises means for detecting a first touch on a touch screen user interface.

12. The method of claim 8, wherein the means for detecting a first subsequent command gesture comprises means for detecting a second touch on a touch screen user interface.

13. The method of claim 9, wherein the means for detecting a second subsequent command gesture comprises means for detecting a third touch on a touch screen user interface.

14. The method of claim 10, wherein the means for detecting a third subsequent command gesture comprises means for detecting a fourth touch on a touch screen user interface.

15. A portable computing device, comprising:
a processor, wherein the processor is operable to:
detect an initial command gesture;
determine whether a first subsequent command gesture is detected;
execute a base command when a first subsequent command gesture is not detected; and
execute a first modified command when a first subsequent command gesture is detected.

16. The device of claim 15, wherein the processor is further operable to:
determine whether a second subsequent command gesture is detected;
execute a first modified command when a second subsequent command gesture is not detected; and
execute a second modified command when a second subsequent command gesture is detected.

17. The device of claim 16, wherein the processor is further operable to:
determine whether a third subsequent command gesture is detected;
executing a second modified command when a third subsequent command gesture is not detected; and
executing a third modified command when a third subsequent command gesture is detected.

18. The device of claim 15, wherein the processor is operable to detect a first touch on a touch screen user interface in order to detect the initial command gesture.

19. The device of claim 15, wherein the processor is operable to detect a second touch on a touch screen user interface in order to detect the first subsequent command gesture.

20. The device of claim 16, wherein the processor is operable to detect a third touch on a touch screen user interface in order to detect the second subsequent command gesture.

21. The device of claim 17, wherein the processor is operable to detect a fourth touch on a touch screen user interface in order to detect the third subsequent command gesture comprises.

22. A machine readable medium, comprising:
at least one instruction for detecting an initial command gesture;
at least one instruction for determining whether a first subsequent command gesture is detected;
at least one instruction for executing a base command when a first subsequent command gesture is not detected; and
at least one instruction for executing a first modified command when a first subsequent command gesture is detected.

23. The machine readable medium of claim 22, further comprising:
at least one instruction for determining whether a second subsequent command gesture is detected;
at least one instruction for executing a first modified command when a second subsequent command gesture is not detected; and
at least one instruction for executing a second modified command when a second subsequent command gesture is detected.

24. The machine readable medium of claim 23, further comprising:
at least one instruction for determining whether a third subsequent command gesture is detected;
at least one instruction for executing a second modified command when a third subsequent command gesture is not detected; and
at least one instruction for executing a third modified command when a third subsequent command gesture is detected.

25. The machine readable medium of claim 22, further comprising at least one instruction for detecting a first touch on a touch screen user interface in order to detect the initial command gesture.

26. The machine readable medium of claim 22, further comprising at least one instruction for detecting a second touch on a touch screen user interface in order to detect the first subsequent command gesture.

27. The machine readable medium of claim 23, further comprising at least one instruction for detecting a third touch on a touch screen user interface in order to detect the second subsequent command gesture.

28. The machine readable medium of claim 24, further comprising at least one instruction for detecting a fourth touch on a touch screen user interface in order to detect the third subsequent command gesture.

29. A method of modifying commands, the method comprising:
detecting one or more command gestures;
determining a number of command gestures;
executing a base command when a single command gesture is detected; and
executing a first modified command when two command gestures are detected.

30. The method of claim 29, further comprising:
executing an Mth modified command when N command gestures are detected.

31. The method of claim 30, wherein the single command gesture comprises a single touch on a touch screen user interface.

32. The method of claim 31, wherein the two command gestures comprise two touches on a touch screen user interface.

33. The method of claim 32, wherein the N command gestures comprise N touches on a touch screen user interface.

34. A portable computing device, comprising:
means for detecting one or more command gestures;
means for determining a number of command gestures;
means for executing a base command when a single command gesture is detected; and
means for executing a first modified command when two command gestures are detected.

35. The device of claim 34, further comprising:
means for executing an Mth modified command when N command gestures are detected.

36. The device of claim 35, wherein the single command gesture comprises a single touch on a touch screen user interface.

37. The device of claim 36, wherein the two command gestures comprise two touches on a touch screen user interface.

38. The device of claim 37, wherein the N command gesture comprise N touches on a touch screen user interface.

39. A portable computing device, comprising:
a processor, wherein the processor is operable to:
detect one or more command gestures;
determine a number of command gestures;
execute a base command when a single command gesture is detected; and
execute a first modified command when two command gestures are detected.

40. The method of claim 39, further comprising:
execute an Mth modified command when N command gestures are detected.

41. The method of claim 40, wherein the single command gesture comprises a single touch on a touch screen user interface.

42. The method of claim 41, wherein the two command gestures comprise two touches on a touch screen user interface.

43. The method of claim 42, wherein the N command gestures comprise N touches on a touch screen user interface.

44. A machine readable medium, comprising:
at least one instruction for detecting one or more command gestures;
at least one instruction for determining a number of command gestures;
at least one instruction for executing a base command when a single command gesture is detected; and
at least one instruction for executing a first modified command when two command gestures are detected.

45. The machine readable medium of claim 44, further comprising:
at least one instruction for executing an Mth modified command when N command gestures are detected.

46. The machine readable medium of claim 45, wherein the single command gesture comprises a single touch on a touch screen user interface.

47. The machine readable medium of claim 46, wherein the two command gestures comprise two touches on a touch screen user interface.

48. The machine readable medium of claim 47, wherein the N command gestures comprise N touches on a touch screen user interface.
